(19) United States
(12) Patent Application Publication
(10) Pub. No.: US 2002/0180601 A1
(43) Pub. Date: Dec. 5, 2002

(54) Beverage locating device

(76) Inventor: Denise Street, Hainesport, NJ (US)

Correspondence Address: Richard W. Goldstein, 2071 Clove Road, Staten Island, NY, 10304, US

(21) Appl. No.: 09/872,023

(22) Filed: Jun. 1, 2001

(51) Int. Cl. G08B 13/14

(52) U.S. Cl. 340/568.1; 340/539; 340/571; 340/693.12

(57) ABSTRACT

A beverage locating device including an insulated container dimensioned for receiving a canned beverage therein. The insulated container has an open upper end and a closed lower end. A speaker is disposed within the closed lower end of the insulated container. The speaker is capable of generating an audible signal.

### BACKGROUND OF THE INVENTION

The present invention relates to a beverage locating device and more particularly pertains to allowing a person to easily locate their beverage.

The use of electronic communications and locating devices is known in the prior art. More specifically, electronic communications and locating devices heretofore devised and utilized for the purpose of allowing items to be found are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,990,790 to Lusareta discloses an insulated beverage container holder with a base that includes circuitry to control sound, light and motion. U.S. Pat. No. 4,476,469 to Lander discloses a hand held device to assist in the location of an object, such as a key, pen or piece of jewelry, using a battery powered transmitter and receiver pair. U.S. Pat. No. 5,939,981 to Penney discloses means for locating pre-selected objects with a hand-held device and a series of sensors that are affixed to the subjects to be found.

While these devices fulfill their respective, particular objective and requirements, the aforementioned patents do not describe a beverage locating device for allowing a person to easily locate their beverage.

In this respect, the beverage locating device according to the present invention substantially departs from the conventional concepts and designs of the prior art, and in doing so provides an apparatus primarily developed for the purpose of allowing a person to easily locate their beverage.

Therefore, it can be appreciated that there exists a continuing need for a new and improved beverage locating device which can be used for allowing a person to easily locate their beverage. In this regard, the present invention substantially fulfills this need.

### SUMMARY OF THE INVENTION

In the view of the foregoing disadvantages inherent in the known types of electronic communications and locating devices now present in the prior art, the present invention provides an improved beverage locating device. As such, the general purpose of the present invention, which will be described subsequently in greater detail, is to provide a new and improved beverage locating device which has all the advantages of the prior art and none of the disadvantages.

To attain this, the present invention essentially comprises an insulated container dimensioned for receiving a canned beverage therein. The insulated container has an open upper end and a closed lower end. A speaker is disposed within the closed lower end of the insulated container. The speaker is powered by a battery disposed within the closed lower end of the insulated container. The speaker is capable of generating an audible signal. An activator is in communication with the speaker. The activator includes an activation/deactivation button for starting and stopping the audible signal of the speaker.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved beverage locating device which has all the advantages of the prior art electronic communications and locating devices and none of the disadvantages.

It is another object of the present invention to provide a new and improved beverage locating device which may be easily and efficiently manufactured and marketed.

It is a further object of the present invention to provide a new and improved beverage locating device which is of durable and reliable construction.

An even further object of the present invention is to provide a new and improved beverage locating device which is susceptible of a low cost of manufacture with regard to both materials and labor, and which accordingly is then susceptible of low prices of sale to the consuming public, thereby making such a beverage locating device economically available to the buying public.

Even still another object of the present invention is to provide a new and improved beverage locating device for allowing a person to easily locate their beverage.

Lastly, it is an object of the present invention to provide a new and improved beverage locating device including an insulated container dimensioned for receiving a canned beverage therein. The insulated container has an open upper end and a closed lower end. A speaker is disposed within the closed lower end of the insulated container. The speaker is capable of generating an audible signal.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the beverage locating device constructed in accordance with the principles of the present invention.

FIG. 2 is a cross-sectional side view of the present invention.

The same reference numerals refer to the same parts through the various figures.

### DESCRIPTION OF THE PREFERRED EMBODIMENT

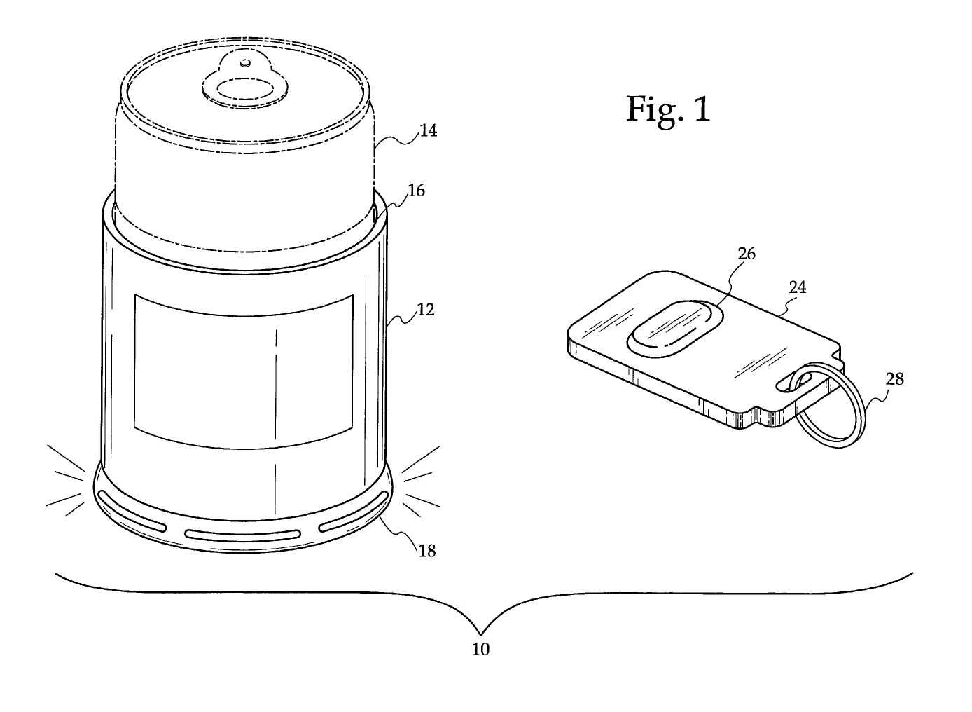

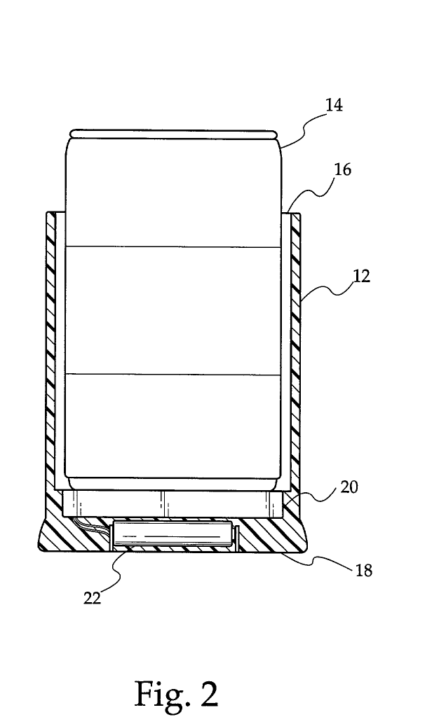

With reference now to the drawings, and in particular, to FIGS. 1 and 2 thereof, the preferred embodiment of the new and improved beverage locating device embodying the principles and concepts of the present invention and generally designated by the reference number 10 will be described.

Specifically, it will be noted in the various figures that the device relates to a beverage locating device for allowing a person to easily locate their beverage. In its broadest context, the device consists of an insulated container, a speaker, and an activator. Such components are individually configured and correlated with respect to each other so as to attain the desired objective.

The insulated container 12 is dimensioned for receiving a canned beverage 14 therein. The insulated container 12 has an open upper end 16 and a closed lower end 18. The insulated container 12 resembles those known in the art that are used to contain canned beverages and preserve them in a cold condition.

The speaker 20 is disposed within the closed lower end 18 of the insulated container 12. The speaker 20 is powered by a battery 22 disposed within the closed lower end 18 of the insulated container 12. The speaker 20 is capable of generating an audible signal. The speaker 20 can be programmed to create a variety of different signals that can distinguish one from another.

The activator 24 is in communication with the speaker 20. The activator 24 includes an activation/deactivation button 26 for starting and stopping the audible signal of the speaker 20. The activator 24 will be adapted to be secured to a user or to an items of the user's. In the preferred embodiment, the activator 24 is provided with a ring 28 to allow keys to be secured thereto. Alternately, the activator 24 could be configured with a belt clip to allow for its securement to a belt of the user.

In use, the user will simply press the activation button 26 to activate the speaker 20. The audible signal created by the speaker 20 will allow the user to locate their beverage. Once the beverage has been located, the user can deactivate the audible signal.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the united states is as follows:

1. A beverage locating device for allowing a person to easily locate their beverage comprising, in combination:
an insulated container dimensioned for receiving a canned beverage therein, the insulated container having an open upper end and a closed lower end;
a speaker disposed within the closed lower end of the insulated container, the speaker being powered by a battery disposed within the closed lower end of the insulated container, the speaker being capable of generating an audible signal; and
an activator being in communication with the speaker, the activator including an activation/deactivation button for starting and stopping the audible signal of the speaker.

2. A beverage locating device for allowing a person to easily locate their beverage comprising, in combination:
an insulated container dimensioned for receiving a canned beverage therein, the insulated container having an open upper end and a closed lower end; and
a speaker disposed within the closed lower end of the insulated container, the speaker being capable of generating an audible signal.

3. The beverage locating device as set forth in claim 2, and further including an activator being in communication with the speaker, the activator including an activation/deactivation button for starting and stopping the audible signal of the speaker.
